(19) United States
(12) Patent Application Publication
(10) Pub. No.: US 2014/0118290 A1
(43) Pub. Date: May 1, 2014

(54) CHIRP SIGNAL TOUCH SENSOR

(71) Applicant: Vemund Kval Bakken, Menlo Park, CA (US)

(72) Inventor: Vemund Kval Bakken, Menlo Park, CA (US)

(21) Appl. No.: 13/665,756

(22) Filed: Oct. 31, 2012

(51) Int. Cl. G06F 3/044

(52) U.S. Cl. CPC G06F 3/044
USPC 345/174

(57) ABSTRACT

In one embodiment, an apparatus includes a drive electrode, a sense electrode, a detector, and a controller. The drive electrode is stimulated by an electric signal that has a frequency that varies in time. The sense electrode is capacitatively coupled to the drive electrode. The detector performs a measurement associated with the sense electrode. The controller determines whether a touch on the touch sensor occurred by determining whether the measurement deviates from an expected value by more than an amount.

### TECHNICAL FIELD

This disclosure generally relates to touch sensors.

### BACKGROUND

A touch sensor may detect the presence and location of a touch or the proximity of an object (such as a user's finger or a stylus) within a touch-sensitive area of the touch sensor overlaid on a display screen, for example. In a touch sensitive display application, the touch sensor may enable a user to interact directly with what is displayed on the screen, rather than indirectly with a mouse or touch pad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch sensor.

There are a number of different types of touch sensors, such as (for example) resistive touch screens, surface acoustic wave touch screens, and capacitive touch screens. Herein, reference to a touch sensor may encompass a touch screen, and vice versa, where appropriate. When an object touches or comes within proximity of the surface of the capacitive touch screen, a change in capacitance may occur within the touch screen at the location of the touch or proximity. A touch-sensor controller may process the change in capacitance to determine its position on the touch screen.

### BRIEF DESCRIPTION OF THE DRAWINGS

FIG. 1 illustrates an example touch sensor with an example touch-sensor controller.

FIG. 2 illustrates an example configuration for a drive electrode and sense electrodes of the touch sensor of FIG. 1.

FIG. 3 illustrates the operation of a portion of the example configuration of FIG. 2.

FIG. 4 illustrates the operation of a portion of the example configuration of FIG. 2 using a chirp signal.

FIG. 5 illustrates the operation of a portion of the example configuration of FIG. 2 using a chirp signal.

FIG. 6 illustrates a method of detecting a touch.

### DESCRIPTION OF EXAMPLE EMBODIMENTS

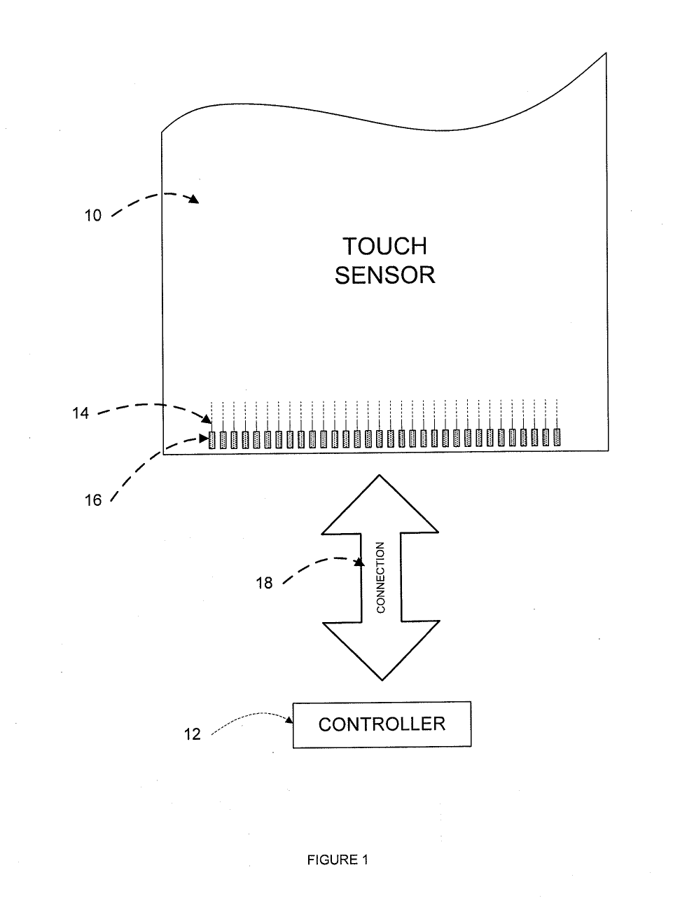

FIG. 1 illustrates an example touch sensor 10 with an example touch-sensor controller 12. Touch sensor 10 and touch-sensor controller 12 may detect the presence and location of a touch or the proximity of an object within a touch-sensitive area of touch sensor 10. Herein, reference to a touch sensor may encompass both the touch sensor and its touch-sensor controller, where appropriate. Similarly, reference to a touch-sensor controller may encompass both the controller and its touch sensor, where appropriate. Touch sensor 10 may include one or more touch-sensitive areas, where appropriate. Touch sensor 10 may include an array of drive and sense electrodes (or an array of electrodes of a single type) disposed on one or more substrates, which may be made of a dielectric material. Herein, reference to a touch sensor may encompass both the electrodes of the touch sensor and the substrate(s) that they are disposed on, where appropriate. Alternatively, where appropriate, reference to a touch sensor may encompass the electrodes of the touch sensor, but not the substrate(s) that they are disposed on.

An electrode (whether a drive electrode or a sense electrode) may be an area of conductive material forming a shape, such as for example a disc, square, rectangle, other suitable shape, or suitable combination of these. One or more cuts in one or more layers of conductive material may (at least in part) create the shape of an electrode, and the area of the shape may (at least in part) be bounded by those cuts. In particular embodiments, the conductive material of an electrode may occupy approximately 100% of the area of its shape. As an example and not by way of limitation, an electrode may be made of indium tin oxide (ITO) and the ITO of the electrode may occupy approximately 100% of the area of its shape, where appropriate. In particular embodiments, the conductive material of an electrode may occupy substantially less than 100% (such as for example, approximately 5%) of the area of its shape. As an example and not by way of limitation, an electrode may be made of fine lines of metal or other conductive material (such as for example copper, silver, or a copper- or silver-based material) and the fine lines of conductive material may occupy substantially less than 100% (such as for example, approximately 5%) of the area of its shape in a hatched, mesh, or other suitable pattern. Although this disclosure describes or illustrates particular electrodes made of particular conductive material forming particular shapes with particular fills having particular patterns, this disclosure contemplates any suitable electrodes made of any suitable conductive material forming any suitable shapes with any suitable fills having any suitable patterns. Where appropriate, the shapes of the electrodes (or other elements) of a touch sensor may constitute in whole or in part one or more macro-features of the touch sensor. One or more macro-features of a touch sensor may determine one or more characteristics of its functionality. One or more characteristics of the implementation of those shapes (such as, for example, the conductive materials, fills, or patterns within the shapes) may constitute in whole or in part one or more micro-features of the touch sensor. One or more micro-features of the touch sensor may determine one or more optical features of the touch sensor, such as transmittance, refraction, or reflection.

A mechanical stack may contain the substrate (or multiple substrates) and the conductive material forming the drive or sense electrodes of touch sensor 10. As an example and not by way of limitation, the mechanical stack may include a first layer of optically clear adhesive (OCA) beneath a cover panel. The cover panel may be clear and made of a resilient material suitable for repeated touching, such as for example glass, polycarbonate, or poly(methyl methacrylate) (PMMA). This disclosure contemplates any suitable cover panel made of any suitable material. The first layer of OCA may be disposed between the cover panel and the substrate with the conductive material forming the drive or sense electrodes. The mechanical stack may also include a second layer of OCA and a dielectric layer (which may be made of PET or another suitable material, similar to the substrate with the conductive material forming the drive or sense electrodes). As an alternative, where appropriate, a thin coating of a dielectric material may be applied instead of the second layer of OCA and the dielectric layer. The second layer of OCA may be disposed between the substrate with the conductive material making up the drive or sense electrodes and the dielectric layer, and the dielectric layer may be disposed between the second layer of OCA and an air gap to a display of a device including touch sensor 10 and touch-sensor controller 12. As an example only and not by way of limitation, the cover panel may have a thickness of approximately 1 mm; the first layer of OCA may have a thickness of approximately 0.05 mm; the substrate with the conductive material forming the drive or sense electrodes may have a thickness of approximately 0.05 mm; the second layer of OCA may have a thickness of approximately 0.05 mm; and the dielectric layer may have a thickness of approximately 0.05 mm. Although this disclosure describes a particular mechanical stack with a particular number of particular layers made of particular materials and having particular thicknesses, this disclosure contemplates any suitable mechanical stack with any suitable number of any suitable layers made of any suitable materials and having any suitable thicknesses. As an example and not by way of limitation, in particular embodiments, a layer of adhesive or dielectric may replace the dielectric layer, second layer of OCA, and air gap described above, with there being no air gap to the display.

One or more portions of the substrate of touch sensor 10 may be made of polyethylene terephthalate (PET) or another suitable material. This disclosure contemplates any suitable substrate with any suitable portions. made of any suitable material. In particular embodiments, the drive or sense electrodes in touch sensor 10 may be made of ITO in whole or in part. In particular embodiments, the drive or sense electrodes in touch sensor 10 may be made of fine lines of metal or other conductive material. As an example and not by way of limitation, one or more portions of the conductive material may be copper or copper-based and have a thickness of approximately 5 μm or less and a width of approximately 10 μm or less. As another example, one or more portions of the conductive material may be silver or silver-based and similarly have a thickness of approximately 5 μm or less and a width of approximately 10 μm or less. This disclosure contemplates any suitable electrodes made of any suitable material.

Touch sensor 10 may implement a capacitive form of touch sensing. In a mutual-capacitance implementation, touch sensor 10 may include an array of drive and sense electrodes forming an array of capacitive nodes. A drive electrode and a sense electrode may form a capacitive node. The drive and sense electrodes forming the capacitive node may come near each other, but not make electrical contact with each other. Instead, the drive and sense electrodes may be capacitatively coupled to each other across a space between them. A pulsed or alternating voltage applied to the drive electrode (by touch-sensor controller 12) may induce a charge on the sense electrode, and the amount of charge induced may be susceptible to external influence (such as a touch or the proximity of an object). When an object touches or comes within proximity of the capacitive node, a change in capacitance may occur at the capacitive node and touch-sensor controller 12 may measure the change in capacitance. By measuring changes in capacitance throughout the array, touch-sensor controller 12 may determine the position of the touch or proximity within the touch-sensitive area(s) of touch sensor 10.

In a self-capacitance implementation, touch sensor 10 may include an array of electrodes of a single type that may each form a capacitive node. When an object touches or comes within proximity of the capacitive node, a change in self-capacitance may occur at the capacitive node and touch-sensor controller 12 may measure the change in capacitance, for example, as a change in the amount of charge needed to raise the voltage at the capacitive node by a pre-determined amount. As with a mutual-capacitance implementation, by measuring changes in capacitance throughout the array, touch-sensor controller 12 may determine the position of the touch or proximity within the touch-sensitive area(s) of touch sensor 10. This disclosure contemplates any suitable form of capacitive touch sensing, where appropriate.

In particular embodiments, one or more drive electrodes may together form a drive line running horizontally or vertically or in any suitable orientation. Similarly, one or more sense electrodes may together form a sense line running horizontally or vertically or in any suitable orientation. In particular embodiments, drive lines may run substantially perpendicular to sense lines. Herein, reference to a drive line may encompass one or more drive electrodes making up the drive line, and vice versa, where appropriate. Similarly, reference to a sense line may encompass one or more sense electrodes making up the sense line, and vice versa, where appropriate.

Touch sensor 10 may have drive and sense electrodes disposed in a pattern on one side of a single substrate. In such a configuration, a pair of drive and sense electrodes capacitatively coupled to each other across a space between them may form a capacitive node. For a self-capacitance implementation, electrodes of only a single type may be disposed in a pattern on a single substrate. In addition or as an alternative to having drive and sense electrodes disposed in a pattern on one side of a single substrate, touch sensor 10 may have drive electrodes disposed in a pattern on one side of a substrate and sense electrodes disposed in a pattern on another side of the substrate. Moreover, touch sensor 10 may have drive electrodes disposed in a pattern on one side of one substrate and sense electrodes disposed in a pattern on one side of another substrate. In such configurations, an intersection of a drive electrode and a sense electrode may form a capacitive node. Such an intersection may be a location where the drive electrode and the sense electrode “cross” or come nearest each other in their respective planes. The drive and sense electrodes do not make electrical contact with each other—instead they are capacitatively coupled to each other across a dielectric at the intersection. Although this disclosure describes particular configurations of particular electrodes forming particular nodes, this disclosure contemplates any suitable configuration of any suitable electrodes forming any suitable nodes. Moreover, this disclosure contemplates any suitable electrodes disposed on any suitable number of any suitable substrates in any suitable patterns.

As described above, a change in capacitance at a capacitive node of touch sensor 10 may indicate a touch or proximity input at the position of the capacitive node. Touch-sensor controller 12 may detect and process the change in capacitance to determine the presence and location of the touch or proximity input. Touch-sensor controller 12 may then communicate information about the touch or proximity input to one or more other components (such one or more central processing units (CPUs) or digital signal processors (DSPs)) of a device that includes touch sensor 10 and touch-sensor controller 12, which may respond to the touch or proximity input by initiating a function of the device (or an application running on the device) associated with it. Although this disclosure describes a particular touch-sensor controller having particular functionality with respect to a particular device and a particular touch sensor, this disclosure contemplates any suitable touch-sensor controller having any suitable functionality with respect to any suitable device and any suitable touch sensor.

Touch-sensor controller 12 may be one or more integrated circuits (ICs)—such as for example general-purpose microprocessors, microcontrollers, programmable logic devices or arrays, application-specific ICs (ASICs). In particular embodiments, touch-sensor controller 12 comprises analog circuitry, digital logic, and digital non-volatile memory. In particular embodiments, touch-sensor controller 12 is disposed on a flexible printed circuit (FPC) bonded to the substrate of touch sensor 10, as described below. In particular embodiments, multiple touch-sensor controllers 12 are disposed on the FPC. In some embodiments, the FPC may have no touch-sensor controllers 12 disposed on it. The FPC may couple touch sensor 10 to a touch-sensor controller 12 located elsewhere, such as for example, on a printed circuit board of the device. Touch-sensor controller 12 may include a processor unit. a drive unit, a sense unit, and a storage unit. The drive unit may supply drive signals to the drive electrodes of touch sensor 10. The sense unit may sense charge at the capacitive nodes of touch sensor 10 and provide measurement signals to the processor unit representing capacitances at the capacitive nodes. The processor unit may control the supply of drive signals to the drive electrodes by the drive unit and process measurement signals from the sense unit to detect and process the presence and location of a touch or proximity input within the touch-sensitive area(s) of touch sensor 10. The processor unit may also track changes in the position of a touch or proximity input within the touch-sensitive area(s) of touch sensor 10. The storage unit may store programming for execution by the processor unit, including programming for controlling the drive unit to supply drive signals to the drive electrodes, programming for processing measurement signals from the sense unit, and other suitable programming, where appropriate. Although this disclosure describes a particular touch-sensor controller having a particular implementation with particular components, this disclosure contemplates any suitable touch-sensor controller having any suitable implementation with any suitable components.

Tracks 14 of conductive material disposed on the substrate of touch sensor 10 may couple the drive or sense electrodes of touch sensor 10 to connection pads 16, also disposed on the substrate of touch sensor 10. As described below, connection pads 16 facilitate coupling of tracks 14 to touch-sensor controller 12. Tracks 14 may extend into or around (e.g. at the edges of) the touch-sensitive area(s) of touch sensor 10. Particular tracks 14 may provide drive connections for coupling touch-sensor controller 12 to drive electrodes of touch sensor 10, through which the drive unit of touch-sensor controller 12 may supply drive signals to the drive electrodes. Other tracks 14 may provide sense connections for coupling touch-sensor controller 12 to sense electrodes of touch sensor 10, through which the sense unit of touch-sensor controller 12 may sense charge at the capacitive nodes of touch sensor 10. Tracks 14 may be made of fine lines of metal or other conductive material. As an example and not by way of limitation, the conductive material of tracks 14 may be copper or copper-based and have a width of approximately 100 μm or less. As another example, the conductive material of tracks 14 may be silver or silver-based and have a width of approximately 100 μm or less. In particular embodiments, tracks 14 may be made of ITO in whole or in part in addition or as an alternative to fine lines of metal or other conductive material. Although this disclosure describes particular tracks made of particular materials with particular widths, this disclosure contemplates any suitable tracks made of any suitable materials with any suitable widths. In addition to tracks 14, touch sensor 10 may include one or more ground lines terminating at a ground connector (which may be a connection pad 16) at an edge of the substrate of touch sensor 10 (similar to tracks 14).

Connection pads 16 may be located along one or more edges of the substrate, outside the touch-sensitive area(s) of touch sensor 10. As described above, touch-sensor controller 12 may be on an FPC. Connection pads 16 may be made of the same material as tracks 14 and may be bonded to the FPC using an anisotropic conductive film (ACF). Connection 18 may include conductive lines on the FPC coupling touch-sensor controller 12 to connection pads 16, in turn coupling touch-sensor controller 12 to tracks 14 and to the drive or sense electrodes of touch sensor 10. In another embodiment, connection pads 16 may be connected to an electro-mechanical connector (such as a zero insertion force wire-to-board connector); in this embodiment, connection 18 may not need to include an FPC. This disclosure contemplates any suitable connection 18 between touch-sensor controller 12 and touch sensor 10.

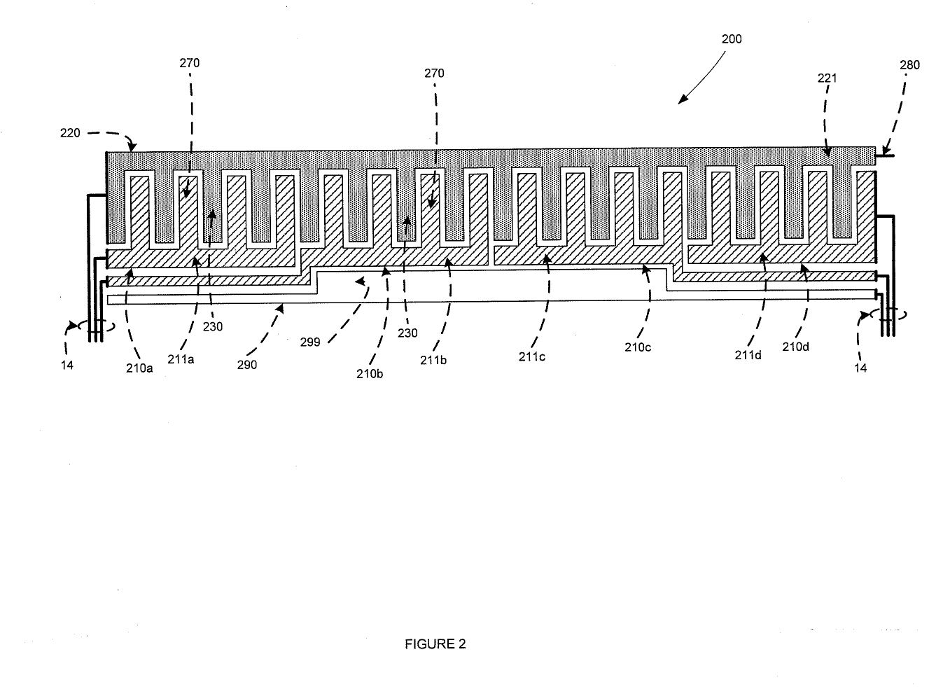

In particular embodiments, touch sensor 10 may have a single-layer configuration, with drive and sense electrodes disposed in a pattern on one side of a single substrate. In such a configuration, a pair of drive and sense electrodes capacitatively coupled to each other across a space between them may form a capacitive node. In particular embodiments, a single-layer configuration of drive and sense electrodes may satisfy geometry and space constraints with respect to the construction of touch sensor 10. Particular embodiments and examples of single-layer configurations of drive and sense electrodes will be discussed further with respect to FIGS. 2A through 6B.

FIG. 2 illustrates an example single-layer configuration 200 for a drive electrode 220 and sense electrodes 210 of the touch sensor 10 of FIG. 1. In particular embodiments, single-layer configuration 200 is suitable for one-dimensional touch/proximity sensing, such as for example, in a slider. As provided by FIG. 2, drive electrode 220 is interdigitated with sense electrodes 210 to form single-layer configuration 200. Single-layer configuration 200 is then coupled to a surface of a substrate to be included in touch sensor 10. In this manner, the drive electrode 220 and sense electrodes 210 occupy a single surface of the substrate thereby satisfying space and geometry constraints that may be associated with the design of touch sensor 10. For example, if the drive and sense electrodes had to be on different substrates, the need for two substrates would increase the thickness of the touch sensing module “stack” as compared to a stack having only one substrate. In particular embodiments, the width of gaps between adjacent electrodes is the same.

In particular embodiments, drive electrode 220 includes a plurality of digits 230. Each digit 230 has a particular length and width. In particular embodiments, each digit 230 is of substantially identical length and width. Each digit 230 extends from a base portion 221 of drive electrode 220 and is separated from a neighboring digit 230 by a space, a part of which is occupied by a digit 270 of a sense electrode 210. The base portion 221 of drive electrode 220 extends the length of single-layer configuration 200. Base portion 221 of drive electrode 220 includes connecting sections 225. Connecting sections 225 form the portions of base portion 221 that couple neighboring digits 230. In configuration 200, connecting sections 225 couple to the ends of digits 230. Drive electrode 220 couples to a track 14.

Single-layer configuration 200 includes sense electrodes 210. In the example of FIG. 2, single-layer configuration 200 includes four sense electrodes 210a-d. In particular embodiments, each sense electrode includes a particular number of digits 270. Each digit 270 extends from a base portion 211 of a sense electrode 210. Digits 270 occupy part of the space that separates digits 230 of drive electrode 220. In particular embodiments, the base portions 211 of sense electrodes 210 and digits 270 capacitatively couple to the base portion 221 of drive electrode 220 and digits 230 across a space 240 to provide a touch/proximity sensor that, with a controller 12, can sense the location of fingers and/or objects that touch and/or in proximity to touch sensor 10. A plurality of sense electrodes 210 are configured in a pattern across single-layer configuration 200. As an example and not by way of limitation, four sense electrodes 210a-d are positioned across single-layer configuration 200. Each sense electrode 210a-d includes the same number of digits 270. The base portions of sense electrodes 210a-d are of similar lengths and are spaced evenly across single-layer configuration 200.

Sense electrodes 210 are coupled to tracks 14. In particular embodiments, sense electrodes 210 couple to tracks 14 along the edges of single-layer configuration 200. As an example and not by way of limitation, tracks 14 for sense electrodes 210 are along the left edge of single-layer configuration 200 and the right edge of single-layer configuration 200. Sense electrodes 210 along the left side of single-layer configuration 200 such as, for example sense electrodes 210a and 210b, couple to tracks 14 along the left edge of single-layer configuration 200. Sense electrodes 210 on the right side of single-layer configuration 200 such as, for example sense electrodes 210c and 210d, couple to tracks 14 along the right edge of single-layer configuration 200. In particular embodiments, vias or insulated bridges are used to route tracks 14 coupled to sense electrodes 210 along the top edge of single-layer configuration 200. Vias are openings made through the substrate, through which the tracks 14 can pass, so that they can continue along the opposite surface of the substrate from the electrodes. Insulated bridges are portions of dielectric or insulating material that are used at locations where a track intersects with other conductive elements to prevent direct electrical contact of the track with the other conductive element.

Single-layer configuration 200 includes a ground line 290 through which drive electrodes 220 and sense electrodes 210 capacitatively couple to ground, in particular embodiments. Ground line 290 couples to a track 14 along an edge of single-layer configuration 200.

An electric signal is sent through signal line 280 to drive or stimulate drive electrode 220 in particular embodiments. As drive electrode 220 is electrically stimulated, a resulting electric charge will build on sense electrodes 210a, 210b, 210c, and 210d. The resulting voltage is then measured to determine whether an object such as a finger is touching or near touch sensor 10.

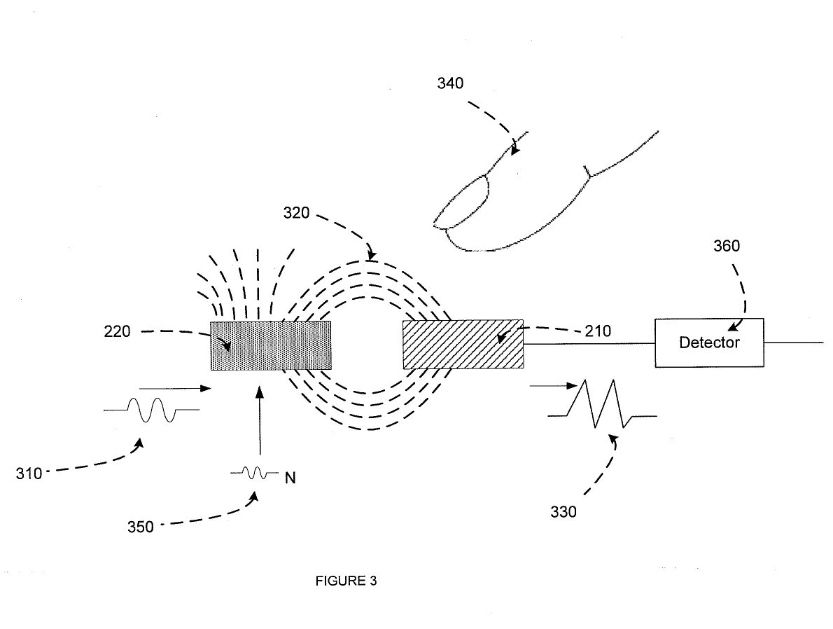

FIG. 3 illustrates the operation of a portion of the example configuration 200 of FIG. 2. As provided by FIG. 3, the portion of example configuration 200 includes drive electrode 220 and sense electrode 210. Drive electrode 220 and sense electrode 210 are arranged in a mutual capacitance implementation.

Drive electrode 220 is stimulated or driven by an electric signal 310 in particular embodiments. Electric signal 310 is an alternating voltage electric signal. Electric signal 310 may be sinusoidal, square, triangular, or any other appropriate alternating voltage signal. In the example illustrated in FIG. 3, electric signal 310 is sinusoidal and has a particular frequency.

As electric signal 310 stimulates drive electrode 220, an electric field 320 may form between drive electrode 220 and sense electrode 210. Electric field 320 will increase and decrease in strength as electric signal 310 alternates. As the strength of electric field 320 increase and decreases, a resulting charge will build and dissipate on sense electrode 210. As charge builds and dissipates, an output signal 330 rises and falls across sense electrode 210. Circuit elements of touch sensor 10 perform measurements associated with the rise and fall of output signal 330 to determine if an object, such as finger 340, is near or touching touch sensor 10.

For example, sense electrode 210 may be electrically coupled to any suitable signal enhancement circuit, such as a linear amplifier, and any suitable detector 360. such as an ADC. The detector 360 provides a measure of any object's, such as a finger or stylus, impact on the sense electrode 210. When finger 340 is near or touching touch sensor 10, finger 340 will disrupt electric field 320, because finger 340 impacts the dielectric between drive electrode 220 and sense electrode 210. Disrupting electric field 320 will affect output signal 330. As a result, detector 360 may detect a deviation and/or change in output signal 330, such as in frequency, phase, and/or amplitude. Controller 12 and/or touch sensor 10 may determine that an object such as finger 340 is near or touching touch sensor 10 in response to this detection. Detector 360 may be any suitable detector 360 to detect an object near sensor 10, such as for example an AC to DC converter with a sample and hold circuit, a frequency detector, and/or a phase detector. Detector 360 may detect any suitable change associated with sense electrode 210. For example, detector 360 may detect a change in the capacitance associated with drive electrode 220 and sense electrode 210.

Problems occur when noise 350 is introduced. Noise 350 may be caused by any number of factors. For example, noise 350 may be introduced by a device embodying touch sensor 10. As another example, noise 350 may be introduced by charge buildup on other elements of the device embodying touch sensor 10. Noise 350 may also be caused by sources external to the device such as by chargers, lights, and any other suitable electric device. Noise 350 may cause a number of undesirable effects in the device. For example, when the frequency of noise 350 is a harmonic of the frequency of electric signal 310, noise 350 may begin to stimulate drive electrode 220. This extra stimulation will affect electric field 320. For example, noise 350 may weaken electric field 320 at certain points throughout a period of noise 350. The weakening of electric field 320 may cause detector 360 to erroneously determine that an object is near touch sensor 10. This disclosure contemplates noise 350 being of any suitable frequency that affects sensor 10. For example, the frequency of noise 350 may not be a harmonic of the frequency of electric signal 310 and still introduce undesirable effects associated with touch sensor 10. To address the problems introduced by noise 350, a chirp signal may be used in place of electric signal 310.

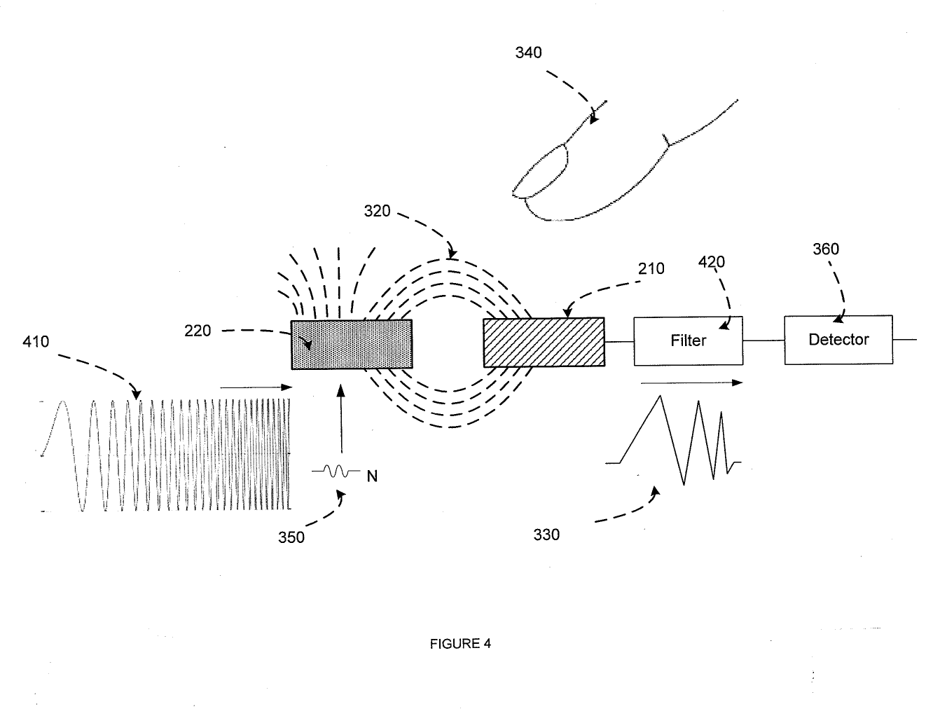

FIG. 4 illustrates the operation of a portion of the example configuration 200 of FIG. 2 using a chirp signal 410. Chirp signal 410 may have a varying frequency and/or amplitude. In the example illustrated in FIG. 4, chirp signal 410 has a frequency that increases or decreases from pulse to pulse. The rate at which the frequency increases may be controlled or uncontrolled, and may not be continuous. As an example, the first pulse of chirp signal 410 may have a frequency of 200 kilohertz, the second pulse may have a frequency of 201 kilohertz, the third pulse may have a frequency of 202 kilohertz, and so on. The chirp signal 410 reaches a maximum frequency after which the frequency of the chirp signal 410 may decrease or reset to the original frequency. In some cases, the rate at which the frequency increases and decreases is randomized. Chirp signal 410 may be sinusoidal, a square wave, triangular, or any other appropriate shape. Chirp signal 410 may be generated by switches, a digital-to-analog converter, or any other appropriate signal generator.

Noise 350 will affect a small, uncorrelated number of frequencies of chirp signal 410 because the frequency of chirp signal 410 varies in time. In theory, noise 350 affects a particular frequency of chirp signal 410 only if the frequency of noise 350 is a harmonic of the particular frequency. By controlling the frequencies of chirp signal 410, it is possible to have noise 350 affect none or a limited set of frequencies of chirp signal 410. As a result, chirp signal 410 is a signal that is resistant to noise 350. Thus, by stimulating drive electrodes 220 with chirp signal 410, touch sensor 10 becomes more resilient to the influence of noise 350. In this manner, even when noise 350 is prevalent, touch sensor 10 may accurately detect objects, such as finger 340.

Filter 420 is electrically coupled to sense electrode 210 and detector 360. Filter 420 filters output signal 330, in particular embodiments. If the frequency of noise 350 is known, filter 420 may be tuned to filter out or blacklist the frequency of noise 350. Control logic may also be used so that chirp signal 410 does not include the blacklisted frequencies. For example. control logic may control a signal generator that generates chirp signal 410 so that chirp signal 410 does not include the blacklisted frequencies.

Filter 420 is a time or frequency varying filter, in another embodiment. Filter 420 may be tuned to pass frequencies that are approximately equal to the frequency of the chirp signal 410. Control logic may tune the time-varying or frequency-varying filter 420. The bandwidth of filter 420 (i.e. the band of frequencies that filter 420 is tuned to pass) may be broadened or narrowed to adjust the effectiveness of filter 420 in filtering out noise 350. At a first point in time. the chirp signal 410 may have a frequency of 200 Hertz. At that time. the pass band of the filter 420 may be tuned to pass 200 kilohertz signals. At another time, the chirp signal 410 may have a frequency of 205 kilohertz. At that time, the pass band of the filter 420 may be shifted or tuned to pass 205 kilohertz signals. At these points in time, the pass band of the filter 420 may be centered on 200 kilohertz and 205 kilohertz respectively. The bandwidth of the filter 420 may be 2 kilohertz such that at the first point in time, the filter 420 passes frequencies from 199 Hertz to 201 Hertz, and at the second point in time, 204 Hertz to 206 Hertz. As a result, the filter 420 will filter out frequency components that may have been caused by noise 350. Hence, noise 350 will only affect a small portion of output signal 330 such that the chances of touch sensor 10 erroneously detecting an object such as finger 340 will be reduced. Although not illustrated, output signal 330 may be amplified before and/or after being sent through filter 420.

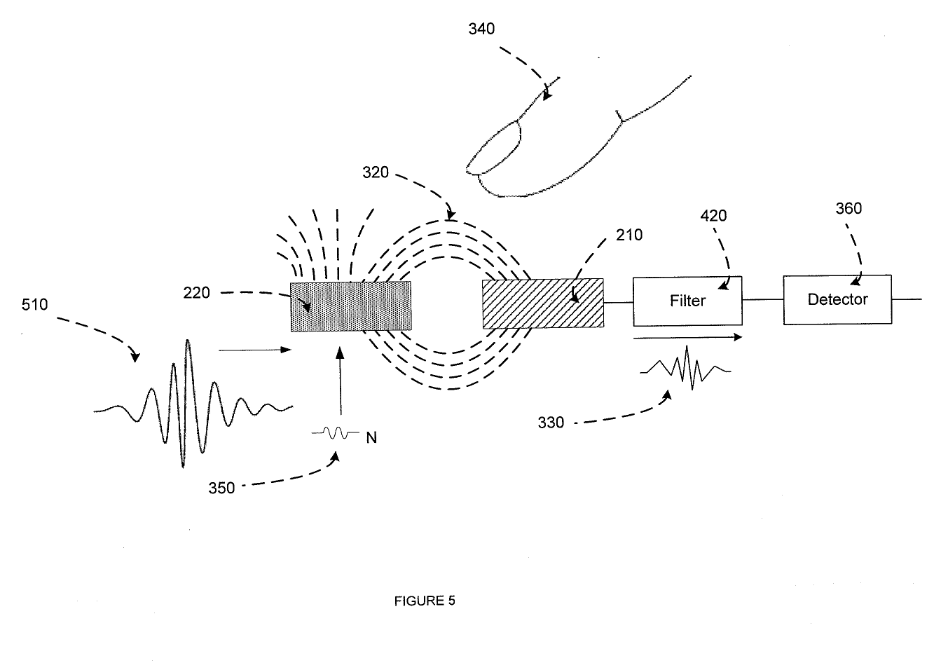

FIG. 5 illustrates the operation of a portion of the example configuration 200 of FIG. 2 using a chirp signal 510. Chirp signal 510 has a frequency that varies in time. For example, the frequency of chirp signal 510 may increase to a peak frequency and then decrease. Furthermore, the amplitudes of the pulses of chirp signal 510 vary in time. By varying the amplitude of chirp signal 510, chirp signal 510 can be made more resistant to noise 350. For example, the amplitude of chirp signal 510 can be increased when the frequency of chirp signal 510 is approximately a harmonic of noise 350 thereby lessening the effect of noise 350 on chirp signal 510. Because noise 350 has its greatest effect on chirp signal 510 when the frequency of chirp signal 510 is a harmonic of the frequency of noise 350, the increased amplitude of chirp signal 510 essentially drowns out noise 350.

Moreover, a device embodying touch sensor 10 may perform signal analysis on output signal 330. For example, because the amplitude and frequency of chirp signal 510 are known, the device may abstract the chirp signal 510 from output signal 330. As another example, the device may perform digital integration on output signal 330 based on the amplitude and frequency of chirp signal 510. An element of the device such as controller 12 may perform the signal analysis.

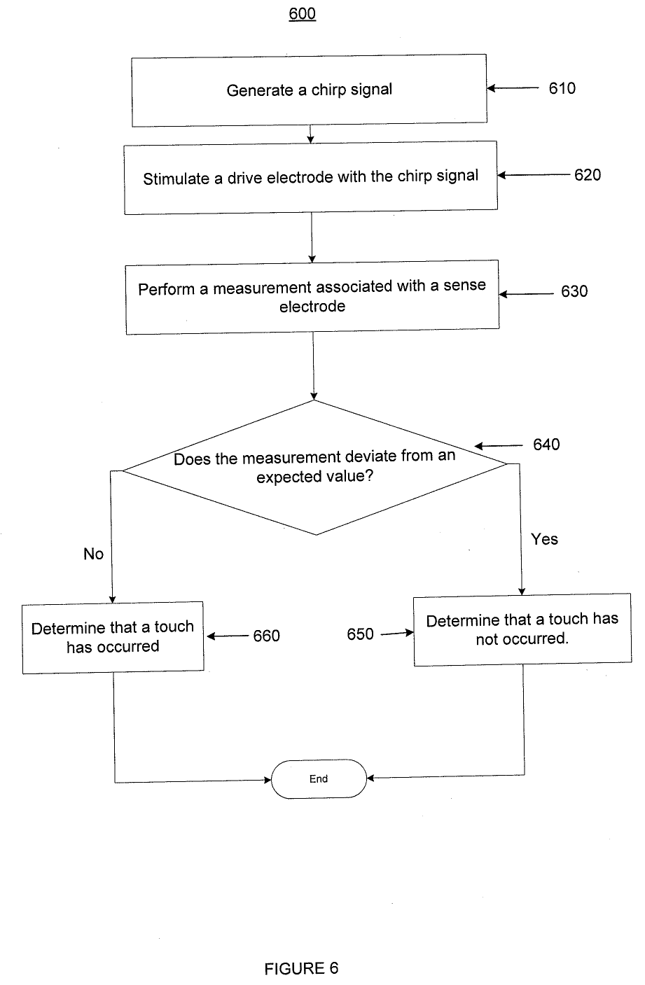

FIG. 6 illustrates a method 600 of detecting a touch. A device embodying touch sensor 10 and touch sensor controller 12 may perform method 600. In step 610, the device generates a chirp signal. In particular embodiments, the chirp signal has a frequency that varies in time and/or an amplitude that varies in time. In step 620, the device stimulates a drive electrode with the chirp signal. In particular embodiments, the drive electrode is capacitatively coupled to a sense electrode. Stimulation of the drive electrode causes a charge to build on the sense electrode. The buildup and eventual dissipation of charge results in a voltage at the sense electrode. The sense electrode may be electrically coupled to a detector that may perform measurements associated with the voltage at the sense electrode. For example, the detector may measure the capacitance across the drive electrode and the sense electrode. If the capacitance deviates from an expected capacitance, the device may determine that an object is near or touching touch sensor 10.

In step 630, the device performs a measurement associated with the sense electrode. For example, a detector coupled to the sense electrode may measure the capacitance associated with the drive electrode and the sense electrode. As another example, the detector may measure the output signal produced by the sense electrode. The detector may perform a time, amplitude, frequency, and/or phase measurement associated with the output signal of the sense electrode This disclosure contemplates the device performing any suitable measurement associated with the sense electrode in order to determine whether an object is near or touching the touch sensor 10.

In step 640, the device determines whether the measurement deviates from an expected value. In particular embodiments, the device determines whether the measurement deviates from the expected value by more than a amount. For example, the device may determine whether a measured capacitance associated with the drive electrode and the sense electrode deviates from an expected capacitance. If an object is near or touching touch sensor 10, it may impact the dielectric between the drive electrode and the sense electrode, which would affect the measured capacitance. As another example, the device may determine whether a frequency or amplitude associated with an output signal of the sense electrode deviates from an expected frequency or amplitude.

If the measurement is does not deviate from the expected value, then the device determines that a touch has not occurred in step 650. If the measurement deviates from the expected value, then the device determines that a touch has occurred in step 670. In particular embodiments, the device determines that a touch occurred if the measurement does not deviate from the expected value by more than an amount, otherwise the device determines that a touch did not occur.

Although this disclosure describes single-layer configuration 200 including a particular number of drive electrodes 220 configured in a particular manner, this disclosure contemplates single-layer configuration including any suitable number of drive electrodes 220 configured in any suitable manner. Although this disclosures describes single-layer configuration 200 including a particular number of sense electrodes 210, this disclosure contemplates single-layer configuration 200 including any suitable number of sense electrodes 210. Although this disclosure describes single-layer configuration 200 including a particular number of sense electrodes 210 with a particular number of digits 270 configured in a particular manner, this disclosure contemplates single-layer configuration 200 including any suitable number of sense electrodes 210 with any suitable number of digits 270 and configured in any suitable manner. Although this disclosure describes single-layer configuration 200 including tracks 14 arranged in a particular manner, this disclosure contemplates single-layer configuration 200 including tracks 14 arranged in any particular manner. Although this disclosure describes single-layer configuration 200 including a ground line 290 configured in a particular manner, this disclosure contemplates single-layer configuration 200 including a ground line 290 configured in any particular manner.

Although this disclosure describes tracks 14 coupling to drive electrodes 220a and 220b in a particular manner, this disclosure contemplates tracks 14 coupling to drive electrodes 220a and 220b in any suitable manner. Although this disclosure describes drive electrodes 220 configured in a particular manner, this disclosure contemplates drive electrodes 220 configured in any suitable manner. Although this disclosure describes sense electrodes 210a-d arranged in a particular manner across single-layer configuration 200, this disclosure contemplates arranging sense electrodes 210a-d in any suitable manner across single-layer configuration 200. Although this disclosure describes sense electrodes 210 coupling to tracks 14 in a particular manner, this disclosure contemplates sense electrodes 210 coupling to tracks 14 in any suitable manner. Although this disclosure describes single-layer configuration 200 including a particular number of ground lines 290 arranged in a particular manner, this disclosure contemplates a single-layer configuration 200 including any suitable number of ground lines 290 arranged in any suitable manner. Although this disclosure describes single-layer configuration 300 being formed from a particular number of single-layer configurations 200 arranged in a particular manner, this disclosure contemplates single-layer configuration 300 being formed from any suitable number of single-layer configurations 200 arranged in any suitable manner. Although this disclosure describes tracks 14 arranged in a particular manner, this disclosure contemplates tracks 14 arranged in any suitable manner.

Although this disclosure describes a particular digit 230 coupling to adjacent digits 230 at particular points, this disclosure contemplates any suitable digit 230 coupling to adjacent digits 230 at any suitable points. Although this disclosure describes drive electrode 220 and sense electrodes 210 arranged in a particular manner across single-layer configuration 500, this disclosure contemplates drive electrode 220 and sense electrodes 210 being arranged in any suitable manner across single-layer configuration 500.

Although this disclosure illustrates several configurations of touch sensor 10, these illustrations are not necessarily drawn to scale. Certain features have been exaggerated or enlarged for descriptive purposes. For example, in particular illustrations, the size of the spacing between digits in proportion to the size of the digits has been increased to properly describe the spacing between digits. Although this disclosure illustrates the spacing between digits being of particular sizes, this disclosure contemplates the spacing between digits being of any suitable size. The spacing between digits may be uniform across any particular configuration or the spacing between digits may be non-uniform across any particular configuration.

Although this disclosure describes chirp signals having particular frequencies, this disclosure contemplates chirp signals having any appropriate frequencies. Although this disclosure describes noise 350 being caused by particular sources, this disclosure contemplates noise 350 being caused by any appropriate source. Although this disclosure describes a time varying filter with a particular pass band and bandwidth, this disclosure contemplates a time varying filter with any appropriate pass band and bandwidth.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk. an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a secure digital card, a secure digital drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. An apparatus comprising:
a signal generator operable to generate an electric signal having a frequency that varies in time:
a drive electrode of a touch sensor operable to be stimulated by the electric signal;
a sense electrode of a touch sensor capacitatively coupled to the drive electrode;
a detector electrically coupled to the sense electrode and operable to perform a measurement associated with the sense electrode; and
a controller operable to determine whether a touch on the touch sensor occurred by determining whether the measurement deviates from an expected value by more than an amount.

2. The apparatus of claim 1 further comprising a filter associated with a variable pass band, wherein the pass band varies according to the frequency of the electric signal.

3. The apparatus of claim 2, wherein the filter is operable to vary the pass band in order to pass the frequency of the electric signal.

4. The apparatus of claim 1 further comprising a filter operable to filter out a frequency associated with a noise signal.

5. The apparatus of claim 1, wherein an amplitude of the electric signal varies according to the frequency of a noise signal.

6. The apparatus of claim 5, wherein the amplitude of the electric signal is greatest when the frequency of the electric signal is a harmonic of the frequency of the noise signal.

7. The apparatus of claim 1, wherein the detector measures a capacitance associated with the drive electrode and the sense electrode.

8. A method comprising:
generating, by a signal generator, an electric signal having a frequency that varies in time;
stimulating a drive electrode of a touch sensor with the electric signal;
performing, by a detector, a measurement associated with a sense electrode capacitatively coupled to the drive electrode;
determining, by a controller, whether a touch occurred in response to a determination whether the measurement deviated from an expected value by an amount.

9. The method of claim 9 further comprising the step of varying a variable pass band associated with a filter in order to pass the frequency of the electric signal.

10. The method of claim 9 further comprising the step of filtering out, by a filter, a frequency associated with a noise signal.

11. The method of claim 9, wherein an amplitude of the electric signal varies in time according to the frequency of a noise signal.

12. The method of claim 12, wherein the amplitude of the electric signal is greatest when the frequency of the electric signal is a harmonic of the frequency of the noise signal.

13. The method of claim 9, wherein the measurement is of a capacitance associated with the drive electrode and the sense electrode.

14. A system comprising:
a generator element operable to generate an electric signal having a frequency that varies in time:
a drive element operable to be stimulated by the electric signal;
a sense element capacitatively coupled to the drive element;
a detecting element electrically coupled to the sense element and operable to perform a measurement associated with the sense element; and
a control element operable to determine whether a touch occurred by determining whether the measurement deviates from an expected value by more than an amount.

15. The system of claim 14 further comprising a filter element associated with a variable pass band, wherein the pass band varies according to the frequency of the electric signal.

16. The system of claim 15, wherein the filter element is operable to vary the pass band in order to pass the frequency of the electric signal.

17. The system of claim 14 further comprising a filter element operable to filter out a frequency associated with a noise signal.

18. The system of claim 14, wherein an amplitude of the electric signal varies according to the frequency of a noise signal.

19. The system of claim 18, wherein the amplitude of the electric signal is greatest when the frequency of the electric signal is a harmonic of the frequency of the noise signal.

20. The system of claim 14, wherein the measurement is of a capacitance associated with the drive element and the sense element.
